(19) United States
(12) Patent Application Publication
(10) Pub. No.: US 2021/0188273 A1
(43) Pub. Date: Jun. 24, 2021

(54) ENHANCED VEHICLE OPERATION

(71) Applicant: Ford Global Technologies, LLC, Dearborn, MI (US)

(72) Inventors: Alexander Katriniok, Aachen (DE); Martin Sommer, Aachen (DE); Benedikt Rosarius, Pforzheim (DE)

(73) Assignee: Ford Global Technologies, LLC, Dearborn, MI (US)

(21) Appl. No.: 17/123,857

(22) Filed: Dec. 16, 2020

(30) Foreign Application Priority Data
Dec. 18, 2019 (DE) 102019134886.2

(51) Int. Cl. B60W 30/18; G08G 1/0967; B60W 60/00

(52) U.S. Cl. CPC B60W 30/18159; G08G 1/096725; B60W 60/0027; B60W 2554/4044; B60W 2520/105; G05D 1/0291; B60W 2530/00; B60W 2720/12; B60W 2720/10; B60W 2554/406; B60W 2520/10

(57) ABSTRACT

A computer includes a processor and a memory storing instructions executable by the processor to predict a path of a target vehicle through an intersection, determine a sequence for the target vehicle and a host vehicle to cross through the intersection based the predicted path of the target vehicle and a planned path of the host vehicle, the sequence determined to improve a vehicle parameter among a fleet of vehicles including the host vehicle and the target vehicle, transmit the determined sequence to the target vehicle, and actuate one or more components to move the host vehicle along the planned path according to the determined sequence.

### CROSS REFERENCE TO RELATED APPLICATIONS

This patent application claims priority to German Application No. 102019134886.2, filed Dec. 18, 2019, entitled “System for cooperative adaptation of vehicle movements in the region of a roadway junction, vehicle, movement control device, and computer program product,” which is hereby incorporated herein by its reference in its entirety.

### BACKGROUND

At a roadway junction, two or more roadways, i.e. traffic paths, in particular roads on which vehicles can travel, meet one another and there is the option of turning off using the vehicle and changing the roadway. A roadway junction has at least three feeds if one roadway meets another and ends at it. In particular, a roadway junction is also understood here as an intersection, i.e. a road crossing, at which two or also more roadways intersect (at the same level), so that an intersection has four or also more feeds.

The traffic flow at roadway junctions is presently regulated with the aid of traffic signs, traffic signals, or other priority rules, for example “right before left”, i.e. right-of-way for the respective road user coming from the right, so that it is established which sequence a roadway junction has to be traversed by the road users for crossing or turning off.

However, these rules can be inefficient for vehicles in some traffic situations with respect to travel-relevant parameters, for example the travel time and the fuel consumption. Thus, for example, a red traffic signal, due to the requirement to stop depending on the situation, possibly also unnecessarily obstructs a continuous traffic flow or contributes to an additional time delay with yellow phases, which can possibly be unnecessary depending on the traffic situation. Moreover, roadway junctions, for example intersections, nonetheless represent main areas of accidents in spite of existing priority rules.

A method for intelligently regulating crossings of intersections without traffic lights, i.e. traffic signal, is disclosed in CN 105321362 B. The method is based on vehicle-to-vehicle communication and provides that in consideration of priority criteria such as the vehicle type and a provided priority readable on the license plate, vehicles are accelerated or decelerated during the longitudinal crossing of intersections in order to avoid collisions. The assignment of priority thus takes place on the basis of fixed criteria linked to the vehicle, independently of its current operating state or overarching criteria, for example the total throughput in the present traffic situation. Moreover, automatic lateral monitoring of the travel route or incorporation into correspondingly designed driver assistance systems is not provided, which therefore, if necessary, can only be carried out manually by the driver himself.

A system based on vehicle-to-vehicle communication is presented in U.S. Pat. No. 7,133,767 B2, which enables interactions between drivers of driven vehicles and enables, for example, questions and requests to be communicated, a narrow, poorly visible road to be crossed, maneuvering space to be enlarged on an intersection, or to instruct how an emergency lane is to be formed.

A collision avoidance system for vehicles communicating with one another in the region of roadway junctions is described in U.S. Pat. No. 8,639,437 B2, in which the driver is either warned or an acceleration or braking maneuver is executed to avoid a possible collision. Sideways, i.e. lateral control of the vehicles is not provided. To ascertain whether a collision is possible, an overlap region is determined for various travel routes and action is taken if two vehicles are located simultaneously in the overlap region, wherein vehicles are assigned identification numbers which determine via the priority whether the vehicle is to be accelerated or decelerated for collision avoidance.

An assistance system for collision-free entering of freeways and highways is shown in U.S. Pat. No. 8,810,431 B2, in which an entering vehicle communicates with a vehicle on the target roadway and agrees on a position for the merging maneuver and the vehicle carries out the maneuver in the automated application by braking, acceleration, and steering. The merging takes place in an optimized manner with respect to the individual entering vehicle and not with regard to an increase of the vehicle throughput through the traversed region or another overarching criterion.

An assistance system for driving through an intersection regulated using a traffic signal is presented in U.S. Ser. No. 10/181,264 B2, in which the vehicles communicate with one another in the intersection region and ascertain whether it is critical to drive into the intersection if the traffic signal is just about to switch from green to yellow, i.e. whether the risk of a collision or blocking of the intersection exists. In addition, it can be provided that it is possible to cause an extension of a traffic signal phase to reduce risk.

### SUMMARY

Presently disclosed is a system for cooperative adaptation of vehicle movements in the region of a roadway junction. Moreover, the disclosure relates to a vehicle configured to operate as part of the system, a movement control device for such a vehicle, and a computer program product for configuring or programming a movement control device.

The present disclosure provides, an option for controlling a smooth traffic flow through a region of a roadway junction without using priority rules previously defined independently of the traffic situation.

In an example, a system for cooperative adaptation of vehicle movements in the region of a roadway junction comprises a vehicle fleet, which consists of a plurality of vehicles which each have a vehicle-to-vehicle communication unit, a position detection unit, and a movement control device, wherein the respective movement control device is configured, when a respective vehicle of the vehicle fleet is located at a respective first position in a region of a roadway junction and when one or more other vehicles of the vehicle fleet are also located in the region of the roadway junction, to ascertain a further position of the one or further positions of the multiple other vehicles of the vehicle fleet and to request at least one operating parameter from the vehicles of the fleet in the region of the roadway junction. The respective movement control device is additionally configured here to ascertain a crossing sequence of the vehicles of the fleet through the region on the basis of at least one general fleet-related optimization criterion in consideration of the first and the further positions and the at least one operating parameter of the respective vehicle and of the one or the multiple other vehicles of the fleet in the region of the roadway junction.

In order that the movement control device of the respective vehicle can communicate with other movement control devices of other vehicles of the fleet, i.e. the vehicle fleet, in order, for example, to request the at least one operating parameter, the respective vehicle comprises a vehicle-to-vehicle communication unit connected to the movement control device, i.e. a communication unit for vehicle-to-vehicle (V2V) communication, for example based on ITS/G5 (DSRC) technology (ITS—Intelligent Transport Systems, DSRC—Dedicated Short Range Communication), cellular mobile communication, or another technology which can enable V2V communication. A communication with the infrastructure, i.e. V2I communication, is not absolutely necessary, which simplifies the required system structure and makes it usable at any roadway junction.

A general fleet-related optimization criterion is, in contrast to a special vehicle-related optimization criterion, not designed to optimize the travel route or another parameter of a specific vehicle of the vehicle fleet, but rather to optimize the global performance of the entire fleet with respect to at least one parameter, at least of the vehicles of the fleet in the region of the roadway junction. In this case, this can be, for example, the greatest possible reduction of the total produced carbon dioxide emission or the total consumed fuel or the total waiting time necessary before crossing the roadway junction or maximizing the vehicle throughput, i.e. the number of vehicles which can cross the roadway junction per unit of time. The at least one operating parameter to be requested is dependent on the general fleet-related optimization criterion and can be, for example, the carbon dioxide emission, the fuel type used, the fuel consumption, or also the speed of the vehicle, the current and/or planned travel direction or the planned travel route, etc. The request is performed by the movement control device using the respective vehicle-to-vehicle communication units of the vehicles of the fleet in the region of the roadway junction. The movement control device is designed to request the intrinsic operating parameters of the vehicle, for example the travel speed or the acceleration of the vehicle, via an interface to the vehicle bus, for example a CAN bus, from the suitable vehicle unit.

The respective movement control device is configured to recognize that the respective vehicle is located in the region of a roadway junction. For this purpose, it is connected to the respective position detection unit. The position detection unit comprises, depending on the example, a receiver of a global satellite navigation system, for example a GPS receiver (GPS—global positioning system) and a local digital map or a digital map available via a network or alternatively or additionally one or more surroundings sensors, for example a camera sensor, a radar sensor, and/or a lidar sensor, as well as a programmable device having at least one processor and a memory, configured to analyze the surroundings sensor signals and recognize roadway junctions. The respective movement control device is additionally configured to ascertain the positions of other vehicles of the fleet, i.e. the vehicle fleet, when they are also located in the region of the roadway junction. For this purpose, it is provided that the other vehicle or the other vehicles of the fleet in the region are contacted via vehicle-to-vehicle communication and the position or the positions thereof are requested. Alternatively or additionally, it can be provided that the positions of the other vehicle or the other vehicles are ascertained by analysis of the signals of the surroundings sensor unit.

The region of a roadway junction comprises the area of the roadway junction itself and a roadway region of the feeds. The size of this region can always, for example, be defined as constant (for example, 50 meters) or can be defined as constant as a function of parameters of the roadway junction or roadway, for example permitted highest speed, number of the lanes, etc., and/or for example in dependence on how the respective vehicle determines its position, i.e. at which distance in relation to the roadway junction it can be established that the respective vehicle is moving directly toward the roadway junction.

Every vehicle of the fleet in the region can be the “respective” vehicle per se, while the other vehicles of the fleet in the region are the “other” vehicles. Each of the vehicles in the region per se thus executes the same optimization with respect to the general fleet-related optimization criterion and all participating movement control devices come to the same result with respect to the crossing sequence. In another example, only one movement control device of a vehicle executes the ascertainment of the crossing sequence and then communicates the ascertained crossing sequence to the other vehicles via vehicle-to-vehicle communication.

In an example, the crossing sequence is only determined on the basis of the general fleet-related optimization criterion if a check has the result that no other road users or further vehicles are located in the region of the roadway junction which are not associated with the vehicle fleet and are thus not configured to cooperate with the vehicles of the vehicle fleet during the crossing of the roadway junction. In this case, it can be provided, for example, that the cooperation be omitted and existing traffic rules be followed, for example the “right-before-left rule” or existing signage, either as a whole or at least until the road users which are not part of the vehicle fleet have crossed the roadway junction.

The described system offers the advantage, for example, that the crossing sequence is defined depending on the traffic situation in accordance with the fleet-related optimization criterion, without having to apply priority rules which are possibly not optimum for the present situation. Moreover, the described system is a “mobile” system, which is available when the relevant vehicles at the roadway junction are associated with the system-compatible equipped vehicle fleet. Ideally, all vehicles are equipped accordingly, i.e. all vehicles are part of the vehicle fleet. The system is flexible and efficient since no requirements are placed on the nature of the infrastructure in the region of the roadway junctions. In particular, traffic signs or signal systems do not have to be set up or modified.

The system may avoid collisions in the region of roadway junctions. In one example, a minimum distance is provided, i.e. a distance to the crossing vehicles, i.e. to other vehicles when the travel routes intersect. This distance can be provided statically. However, this distance is preferably defined or calculated so that the system (within certain limits) is designed robustly with respect to parameter uncertainties, for example transient acceleration/braking behavior, coefficients of friction, GPS accuracy, etc. The resulting distance therefore becomes greater when the uncertainties become greater.

Moreover, the system is suitable for increasing the efficiency, for example with respect to fuel consumption, pollutant emission, and traffic flow, with which the vehicle fleet crosses a roadway junction. For example, otherwise necessary waiting times at traffic signals or other traffic signs can be prevented and hazardous situations due to other vehicles, the intention of which of crossing the roadway junction is not recognized in a timely manner by a vehicle or its driver or in which there is a risk of collision, can be reduced or avoided. Because the definition of the crossing sequence can already take place directly upon entry into the region of the roadway junction, a proactive organization of the traffic flow at the roadway junction is possible instead of a solely reactive one, in which the driver or also an automatic controller of the vehicle reacts in accordance with the traffic signs.

In one example, the respective movement control device is additionally configured to adapt a planned travel route of the respective vehicle through the region of the roadway junction on the basis of at least one vehicle-related optimization criterion. An adaptation of the planned travel route thus takes place in consideration of a vehicle-related optimization criterion, which has the goal, for example, of an improvement of the driving comfort for the vehicle occupant or occupants, as a function of the ascertainment of the crossing sequence on the basis of the general fleet-related optimization criterion. In one example, this can take place sequentially. In another example, the optimizations take place simultaneously and mutually influence one another, i.e. the sequence in which the roadway junction is crossed not only influences the optimization of the planned travel route, but rather the planned travel route has effects on the ascertainment of the crossing sequence. The planned travel route comprises items of information on the planned travel path, but also on the planned speed, accelerations and decelerations, and possibly travel direction changes.

In one example, the at least one vehicle-related optimization criterion comprises an adaptation of accelerations and decelerations of the respective vehicle to a driving comfort profile defined for the respective vehicle. A driving comfort profile defined for the vehicle can, for example, be one of multiple standard profiles defined at the factory and/or can be selectable or configurable by the driver. Standard profiles can include, for example, “normal”, “sporty”, “cruise”, or the like. However, it can also be provided that the driver himself defines, for example, maximum permitted accelerations and decelerations, in each case longitudinally and laterally, possibly also permitted duration of an acceleration and gradient of the acceleration and deceleration. Thus, for example abrupt braking, unexpectedly strong steering movements, an abrupt change from slow travel to full gas, inter alia, can be permitted or not permitted.

For example, the at least one vehicle-related optimization criterion comprises an adaptation of a current speed of the respective vehicle to a recommended speed. The recommended speed can be a desired recommended speed selected by the driver or can result from the highest speed permitted on the roadway or the proposed recommended speed.

For example, the respective movement control device is configured to receive another planned travel route of the one other vehicle or other planned travel routes of the multiple other vehicles and to adapt the planned travel route of the respective vehicle in consideration of the one or the multiple other planned travel routes. In this way, it is ensured that changes to planned travel routes which take place due to the vehicle-related optimization criteria of the participating vehicles of the fleet are nonetheless taken into consideration cooperatively in the optimization of all planned travel routes of the vehicles, whereby in particular the collision avoidance is further improved.

For example, the movement control device is configured to continuously receive updates of the one or the multiple other planned travel routes and to continuously adapt the planned travel route of the respective vehicle in consideration of the updates. The continuous updating takes place here at least until the region of the roadway junction has been crossed by the vehicle having the movement control device. The term “continuous” updating also comprises updates at regular time intervals and also updates precisely when something has changed in the already transmitted data.

For example, the respective movement control device is configured to control vehicle dynamics of the respective vehicle for the travel route along a longitudinal movement direction of the respective vehicle. The control takes place here at least as a function of the ascertained crossing sequence, preferably additionally also as a function of the vehicle-related optimization criterion. The vehicle dynamics along the longitudinal movement direction are controlled in particular by acceleration and deceleration at suitable points in time and for a suitable duration in each case. In this way, it is ensured that in particular a longitudinal crossing of the region of the roadway junction, i.e. for example the crossing of an intersection, can also take place automatically while observing the crossing sequence and possibly oriented to the driving comfort profile for the respective vehicle.

While the travel route along the longitudinal movement direction of the vehicle is automatically controlled by the movement control device, it is provided that a control of a possibly required lateral movement is carried out by the driver. According to the standard SAE J3016, this would correspond to a driver assistance system of SAE autonomy level 1 and can be implemented, for example, as an expansion of an ACC system (ACC—adaptive cruise control) in the region of a roadway junction, which, in addition to vehicles in the travel direction in front of the respective vehicle, also takes into consideration vehicles in cross traffic and transmits ascertained reference acceleration and deceleration values to the corresponding actuator of the system.

For example, the respective movement control device is additionally configured to control the vehicle dynamics of the respective vehicle for the travel route along a lateral movement direction of the respective vehicle. More complex driving maneuvers may thus also be automated, for example turning off or a lane change, for example to avoid a vehicle turning off. According to the standard SAE J3016, a system in which the longitudinal and the lateral movement can be automatically controlled simultaneously (at least temporarily) would correspond to a driver assistance system of the SAE autonomy level 2 (or higher). The planned travel path can be ascertained by a path planning algorithm before the roadway junction is crossed. Such a system can be implemented, for example, as an expansion of a congestion assistance system for the region of a roadway junction. In one example, it is provided, for example, that the movement control device ascertains a signal for a reference acceleration or deceleration or a speed of the respective vehicle for the control of the longitudinal movement and ascertains a reference steering angle or corresponding other signal for the control of the lateral movement and then relays the control signals to the suitable actuators of the respective vehicle, for example to an interface of an ACC system and a steering actuator.

For example, the at least one general fleet-related optimization criterion comprises a minimization of a carbon dioxide emission of the vehicle fleet. This can include, for example, reducing or avoiding speed changes and possibly service lives of vehicles having a high carbon dioxide emission in relation to vehicles having a low or no carbon dioxide emission, so that the quantity of carbon dioxide emitted per unit of time as a whole in the region of the roadway junction is minimized.

For example, the at least one general fleet-related optimization criterion comprises a maximization of a throughput of vehicles of the vehicle fleet in regions of roadway junctions. The throughput of vehicles in a region of a roadway junction corresponds here to the number of vehicles which cross the region per unit of time. A maximization of the throughput helps, for example, to avoid congestion and/or at least keep it as short as possible, to shorten travel times, and to reduce pollutant emission, for example carbon dioxide emission, in the region of the roadway junction.

It is to be noted that a single fleet-related optimization criterion to be optimized can also comprise the simultaneous optimization of two or more parameters, for example the simultaneous optimization of the total carbon dioxide emission and the vehicle throughput.

For example, the respective movement control device comprises at least one positioning unit having at least one first interface and a vehicle control unit, which is connected to the positioning unit, having at least one second interface. In this case, the positioning unit is configured to detect positions and operating parameters of the respective vehicle and the one or the multiple other vehicles of the fleet in the region of the roadway junction as input signals via the at least one first interface and to relate them to one another, i.e. to place them in a shared context, and the vehicle control unit is configured to analyze the input signals related to one another by the positioning unit based at least on the at least one fleet-related optimization criterion and to control at least one or more actuators of the respective vehicle based on the evaluation via the at least one second interface.

The detected positions and operating parameters are in particular the first and the further positions and the at least one operating parameter of the respective vehicle and of the one or the multiple other vehicles of the vehicle fleet. For reception, the positioning unit of the movement control device can be connected via the first interface to the position detection unit and the vehicle-to-vehicle communication unit and also the CAN bus.

In order to relate the input signals, i.e. the positions and operating parameters, to one another and/or to place them in a shared context, the positioning unit comprises a programmable device having processor and memory, which contains code components which, when they are loaded and executed by the processor, cause it, for example, to generate a model of the surroundings of the respective vehicle in which the roadway route in the region of the roadway junction and the other vehicle or the other vehicles or items of information in this regard and possibly items of information about the infrastructure are contained. In one example, the positioning unit is moreover configured to classify the other vehicles, for example on the basis of their movement direction, for example as intersecting, oncoming, traveling in the same travel direction, as on a collision course or not on a collision course, etc.

The vehicle control unit comprises, for example, a separate programmable device for evaluating the input signals related to one another. Alternatively, the movement control device can also include, for example, a shared programmable device for the positioning unit and the vehicle control unit.

The vehicle control unit of the movement control device evaluates the input signals related to one another by the positioning unit based at least on the fleet-related optimization criterion and defines a crossing sequence in which the fleet-related optimization criterion, for example minimizing the total carbon dioxide emission of the participating vehicles of the fleet or maximizing the vehicle throughput in the region of the roadway junction or also both simultaneously, is at least approximately optimally fulfilled. It can be provided here that the vehicle control units of all participating vehicles each themselves perform the respective evaluations and send their results to the other participating vehicles in order to ensure that in each case the same crossing sequence was always ascertained, and in the event of a deviation, to define a sequence which is binding for all. Alternatively, it can also be provided that one vehicle control unit ascertains the crossing sequence and communicates it to the others in a binding manner.

In addition, it can be provided that the vehicle control unit of the movement control device of the respective vehicle takes into consideration a respective vehicle-related optimization criterion. In one example, in the context of the travel route of the respective vehicle defined by the crossing sequence, it is adapted on the basis of the vehicle-related optimization criterion, which is oriented, for example, to improving the specific driving comfort. In another example, it is provided that effects of the adaptation of the travel route are in turn used for an updated ascertainment of the crossing sequence with respect to the fleet-related optimization criterion, in order to approximate optimization of both the fleet-related and also the vehicle-related criteria cooperatively and in this case to avoid collisions in spite of dynamic adaptation.

The vehicle control unit then sends suitable control signals via the second interface to the relevant actuator or actuators of the respective vehicle. The actuators are also parts of the system. Depending on the degree of automation, these can be signals which for example act on the brake of the respective vehicle and/or accelerate it and/or influence its steering and/or activate and deactivate the turn signals and/or possibly give the driver a signal to act on the vehicle accordingly.

For example, a vehicle having a movement control device is provided, which is configured for operation in a system for cooperative adaptation of vehicle movements in the region of a roadway junction. Moreover, a movement control device is provided which is configured for operation in a vehicle. In this way, the advantages and special features of the system, including each of the examples, are also implemented in the scope of a suitable vehicle and a suitable movement control device.

For example, the movement control device comprises a programmable device having at least one processor and a memory which contains code components which, when they are executed by the processor, cause the movement control device to operate the vehicle as a vehicle.

For example, a computer program product comprises code components which, when they are executed by a processor of a programmable device of such a movement control device, cause the movement control device to operate the vehicle as a vehicle. In this way, the advantages and special features of the movement control device are also implemented in the scope of a suitable computer program product. Moreover, a computer-readable storage medium having a computer program product is provided.

Further advantages of the present disclosure are apparent from the detailed description and the figures. The disclosure is also explained in greater detail hereinafter in conjunction with the following description of examples with reference to the appended figures.

### BRIEF DESCRIPTION OF THE DRAWINGS

FIG. 1 shows a schematic illustration of an example of a system for cooperatively adapting vehicle movements in the region of a roadway junction.

FIG. 2 shows a schematic illustration of an example of a vehicle having movement control device.

FIG. 3 shows a schematic illustration of diagrams of the curve of speed and interval of two vehicles during the crossing of an intersection.

### DETAILED DESCRIPTION

Other examples can be used and structural or logical changes can be performed without deviating from the scope of protection of the present disclosure. The features of the various examples described above and hereinafter can be combined with one another if not specifically indicated otherwise. The description is therefore not to be interpreted in a restrictive sense, and the scope of protection of the present disclosure is described by the appended claims.

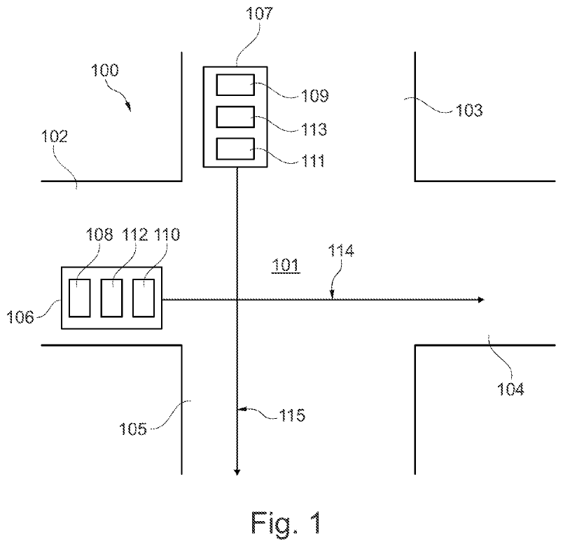

FIG. 1 shows a schematic illustration of an example of a system for cooperative adaptation of vehicle movements in the region of a roadway junction. The system 100 is used for cooperative adaptation of vehicle movements in the region of a roadway junction 101. In the example shown, the roadway junction is an intersection and has a first feed 102, a second feed 103, a third feed 104, and a fourth feed 105. The system 100 comprises a vehicle fleet, which consists in the example shown of a first vehicle 106 and a second vehicle 107 in the region of the roadway junction 101, wherein both the first vehicle 106 and also the second vehicle 107 have a vehicle-to-vehicle communication unit 108, 109, a position detection unit 110, 111, and a movement control device 112, 113, respectively. The first vehicle 106 and the second vehicle 107 are located in the region of the roadway junction 101, which in the example shown comprises the actual intersection region, in which the roadways overlap, and additionally a component of the feeds 102, 103, 104, 105, which is defined in the example shown at a constant length, for example 50 m per feed.

The movement control device 112 of the first vehicle 106, which is located at a first position in a region of a roadway junction 101, determines its own first position on the basis of the items of position information currently provided by the position detection unit 110 and the further position of the second vehicle 107 with the aid of its own vehicle-to-vehicle communication unit 108, via which a communication connection is established to the vehicle-to-vehicle communication unit 109 of the second vehicle 107 and the other position of which is retrieved or provided by the movement control device 113 thereof. In order to be able to provide the position information of the second vehicle, the movement control device 113 of the second vehicle 107 ascertains it with the aid of the position detection unit 111 of the second vehicle 107. Moreover, the movement control device 112 of the first vehicle is configured to request at least one operating parameter from the first vehicle 106 and with the aid of the vehicle-to-vehicle communication from the second vehicle 107 and to ascertain a crossing sequence of the vehicles 106, 107 of the vehicle fleet through the region on the basis of a general fleet-related optimization criterion. In the example shown, it is provided that the movement control device 113 of the second vehicle 107 performs the same ascertainment of the crossing sequence and a comparison of the ascertained crossing sequences takes place via the vehicle-to-vehicle communication connection.

The general fleet-related optimization criterion, which is known to the vehicles of the vehicle fleet, relates, for example, to minimizing the pollutant emission, for example carbon dioxide emission, of the vehicle fleet as a whole or maximizing the throughput of vehicles through the roadway junction, which in the present case means the selection of the sequence in which both the first vehicle 106 having a planned travel route 114 from the first feed 102 to the third feed 104 and also the second vehicle 107 having a planned travel route 115 from the second feed 103 to the fourth feed 105 can traverse the intersection in the overall shortest timeframe. The operating parameter is dependent on the fleet-related optimization criterion. For example, if the total carbon dioxide emission is to be minimized, for example, the carbon dioxide emission of the respective vehicle is ascertained as the operating parameter, for example the current value at the currently traveled speed, an average value, or a characteristic curve of the carbon dioxide emission as a function of the speed of the vehicle and/or as a function of speed changes of the vehicle and possibly further operating parameters, for example the respective current operating temperature.

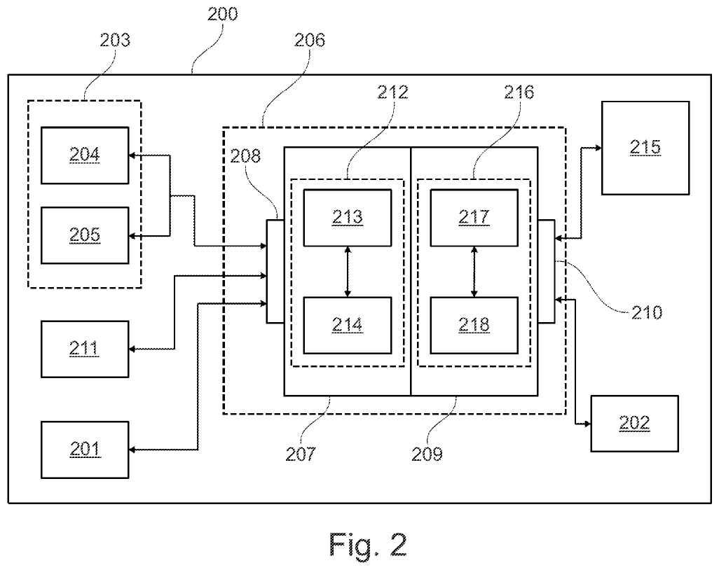

A schematic illustration of an example of a vehicle having movement control device is shown in FIG. 2. The vehicle 200 shown is configured to be operated as first vehicle 106 or second vehicle 107 of the vehicle fleet of the system 100 shown in FIG. 1 for cooperative adaptation of vehicle movements in the region of a roadway junction 101. The vehicle 200 has a vehicle-to-vehicle communication unit, which is shown separately here as receiving module 201 of the vehicle-to-vehicle communication unit and transmitting module 202 of the vehicle-to-vehicle communication unit. Moreover, the vehicle 200 has a position detection unit 203. In the example shown, a GPS receiving unit 204, i.e. a receiver of a global position determination system, and additionally a surroundings sensor unit 205, for example comprising a camera sensor unit and/or a radar sensor unit and/or a lidar sensor unit are provided for position detection, wherein in particular also the position of the vehicle in relation to its surroundings and other vehicles in the region of the roadway junction is detected by analyzing the sensor signals.

Moreover, the vehicle has a movement control device 206, which is configured to ascertain the respective position and at least one operating parameter of vehicles of the vehicle fleet, including the ego vehicle 200, with the aid of the position detection unit 203 and the receiving module 201 and the transmitting module 202 of the vehicle-to-vehicle communication unit, when the vehicle 200 and one or more other vehicles of the vehicle fleet are located in the region of a roadway junction. In the example shown in FIG. 2, the movement control device 206 comprises for this purpose a positioning unit 207 having a first interface 208, and also a vehicle control unit 209, which is connected to the positioning unit 207, having a second interface 210.

The positioning unit 207 of the movement control device 206 is connected via the first interface 208 to the GPS receiving unit 204 and the surroundings sensor unit 205 of the position detection unit 203, and also at least to the receiving module 201 of the vehicle-to-vehicle communication unit. Moreover, there is a connection via the first interface 208 to the vehicle bus 211, for example a CAN bus, via which requests for operating parameter values from vehicle components (not shown) connected to the vehicle bus 211 can take place. The first and the second interface 208, 210 can each themselves consist of a plurality of interfaces.

The positioning unit is configured to detect positions and operating parameters of the vehicle 200 and of other vehicles of the vehicle fleet in the region of a roadway junction as input signals via the first interface 208 and relate them to one another, i.e. place them in a shared context.

For this purpose, the positioning unit 207 shown has a programmable device 212 having a processor 213 and a memory 214. A program is stored in the memory 214, which contains code components which are loaded and executed by the processor 213, whereby it generates a model of the surroundings of the vehicle 200, in which the roadway route in the region of the roadway junction and other vehicles or the items of position information and possibly for example items of movement information thereof are contained. This can also include, for example, a classification of other vehicles or of their planned travel routes, in particular a determination of a possible risk of collision with respect to the ego planned travel route. Moreover, for example, also taking into consideration additional items of information about the infrastructure ascertained from the analysis of the surroundings sensor signals or received via the communication unit can be provided.

The vehicle control unit 209 connected to the positioning unit 207 evaluates the input signals related to one another by the positioning unit 207 based at least on a fleet-related optimization criterion in consideration of the positions and operating parameters of the vehicle. This also includes that for the vehicles of the fleet included in the model, the crossing sequence is ascertained in which the fleet-related optimization criterion is fulfilled as well as possible.

The vehicle control unit 209 shown has for this purpose a separate programmable device 216 having a processor 217 and a memory 218, wherein a program is stored in the memory 218 which contains code components, which are loaded and executed by the processor 217. The movement control device 206 can also have a shared programmable device for the positioning unit 207 and the vehicle control unit 209 or as a whole can provide all features of both the positioning unit 207 and the vehicle control unit 209 in only one control unit.

The crossing sequence is then communicated via the second interface 210 with the aid of the transmitting module 202 of the vehicle-to-vehicle communication unit to the other vehicles of the fleet in the region of the roadway junction. The other vehicles can comply with the ascertained crossing sequence or communicate whether the crossing sequences ascertained by the other vehicles themselves correspond to the transmitted one, wherein one of the crossing sequences is defined as binding cooperatively in the event of deviations. In addition, it is provided that the vehicle control unit 209 takes into consideration a vehicle-related optimization criterion which is oriented, for example, to improving the specific driving comfort, and effects resulting from this consideration on the travel route are used for an updated ascertainment of the crossing sequence, in order to cooperatively approximate an optimization of both the fleet-related criteria and also the vehicle-related criteria and at the same time to avoid collisions in spite of dynamic adaptation.

The vehicle control unit 209 is configured to transmit signals via the second interface 210 to actuators 215 of the vehicle 200 based on the evaluation, in order to control the vehicle dynamics, in order to steer the vehicle through the region of the roadway junction. Depending on the example or operating mode, the vehicle control unit 209 transmits signals for longitudinal or additionally also for lateral control of the vehicle dynamics and thus of the vehicle 200. For the longitudinal control, the vehicle dynamics are influenced by signals which act on the brakes of the vehicle 200 and/or accelerate it, for example. For additional lateral control, the vehicle dynamics are influenced by signals which influence a steering actuator, for example.

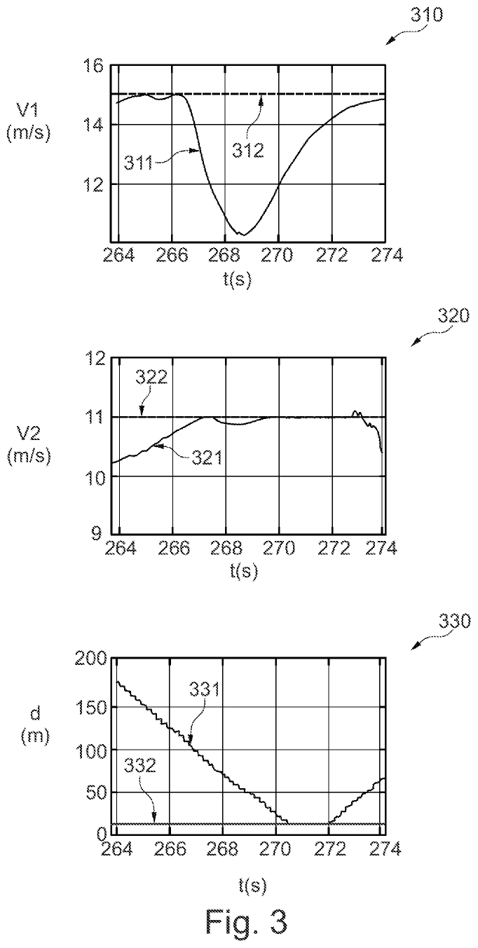

A schematic illustration of diagrams of the curve of speed and interval of two vehicles when traversing an intersection is shown in FIG. 3, wherein the two vehicles are associated with a vehicle fleet of a system for cooperative adaptation of vehicle movements in the region of a roadway junction. The case thus corresponds to the case shown in FIG. 1 of a vehicle fleet consisting of two vehicles having overlapping longitudinal planned travel routes at an intersection. The crossing sequence was ascertained on the basis of a fleet-related optimization criterion. According to the ascertained crossing sequence, for example, the second vehicle receives the priority of being allowed to cross the intersection. The vehicle-related optimization criterion is for both vehicles the desired recommended speed, which was defined for the first vehicle as 15 m/s, i.e. 15 meters per second, and for the second vehicle as 11 m/s.

In the first diagram 310, the exemplary curve 311 of the speed v1 (in meters per second) of the first vehicle over the time t (in seconds) and the desired recommended speed 312 for the first vehicle (also in meters per second) are illustrated. In the second diagram 320, the exemplary curve 321 of the speed v2 (in meters per second) of the second vehicle over the time t (in seconds) and the desired recommended speed 322 for the second vehicle (also in meters per second) are illustrated. In the third diagram 330, the associated exemplary curve 331 of an interval, i.e. a distance d (in meters) between the first vehicle and the second vehicle over the time t (in seconds) and a provided minimum interval 332 to be maintained (also in meters) between both vehicles are illustrated.

While the speed 321 of the second vehicle is increased up to its desired recommended speed 322 of 11 m/s, the speed 311 of the first vehicle, which initially even moves at its desired recommended speed 312 of 15 m/s, is reduced until the decreasing distance 331 between the two vehicles is not reduced below the minimum interval 332, wherein from the point in time at which a collision is no longer possible, the speed 311 of the first vehicle is increased again to approximate it again to the desired recommended speed 312 of the first vehicle. In contrast, it was possible for the second vehicle to traverse the intersection with essentially unchanged speed 321, which is close to the desired recommended speed 322 for the second vehicle.

The figures are not necessarily accurate in detail and scale and can be illustrated enlarged or reduced in size to offer a better overview. Therefore, functional details disclosed here are not to be understood as restrictive, but rather as an illustrative foundation which offers guidance to a person skilled in the art in this field of technology in order to use the present disclosure in manifold ways.

The expression “and/or” used here, if it is used in a series of two or more elements, means that each of the listed elements can be used alone, or any combination of two or more of the listed elements can be used. For example, if a combination is described that contains the components A, B, and/or C, the combination can contain A alone; B alone; C alone; A and B in combination; A and C in combination; B and C in combination; or A, B, and C in combination.

The present disclosure was described in detail on the basis of exemplary embodiments for explanatory purposes. A person skilled in the art recognizes that details described with respect to one embodiment can also be used in other embodiments. The disclosure is therefore not to be restricted to individual embodiments, but rather solely by the appended claims.

### LIST OF REFERENCE SIGNS

100 system
101 roadway junction
102 first feed
103 second feed
104 third feed
105 fourth feed
106 first vehicle
107 second vehicle
108 vehicle-to-vehicle communication unit of the first vehicle
109 vehicle-to-vehicle communication unit of the second vehicle
110 position detection unit of the first vehicle
111 position detection unit of the second vehicle
112 movement control device of the first vehicle
113 movement control device of the second vehicle
114 planned travel route of the first vehicle
115 planned travel route of the second vehicle
200 vehicle
201 receiving module of the vehicle-to-vehicle communication unit
202 transmitting module of the vehicle-to-vehicle communication unit
203 position detection unit
204 GPS receiving unit
205 surroundings sensor unit
206 movement control device
207 positioning unit
208 first interface
209 vehicle control unit
210 second interface
211 vehicle bus
212 programmable device
213 processor
214 memory
215 actuators
216 programmable device
217 processor
218 memory
310 first diagram
311 curve of the speed of the first vehicle
312 desired recommended speed for the first vehicle
320 second diagram
321 speed of the second vehicle
322 desired recommended speed for the second vehicle
330 third diagram
331 distance between the first vehicle and the second vehicle
332 minimum distance between the two vehicles

1-15. (canceled)

16. A system, comprising a computer including a processor and a memory, the memory storing instructions executable by the processor to:
predict a path of a target vehicle through an intersection;
determine a sequence for the target vehicle and a host vehicle to cross through the intersection based the predicted path of the target vehicle and a planned path of the host vehicle, the sequence determined to improve a vehicle parameter among a fleet of vehicles including the host vehicle and the target vehicle;
transmit the determined sequence to the target vehicle; and
actuate one or more components to move the host vehicle along the planned path according to the determined sequence.

17. The system of claim 16, wherein the instructions further include instructions to adjust the planned path of the host vehicle based on the sequence.

18. The system of claim 16, wherein the vehicle parameter includes at least one of a vehicle acceleration, a vehicle acceleration duration, a vehicle speed, emission production rate, or a fuel consumption rate.

19. The system of claim 16, wherein the instructions further include instructions to receive a planned path from the target vehicle and to adjust the planned path of the host vehicle based on the planned path of the target vehicle.

20. The system of claim 16, wherein the vehicle parameter is a carbon dioxide production rate and the instructions further include instructions to determine the sequence to reduce the carbon dioxide production rate of the fleet of vehicles below a production rate threshold.

21. The system of claim 16, wherein the instructions further include instructions to actuate the components to adjust at least one of lateral movement or longitudinal movement of the host vehicle.

22. The system of claim 16, wherein the vehicle parameter is a traffic rate, the traffic rate being a maximum number of vehicles traveling through the intersection during a specified period of time.

23. The system of claim 16, wherein the instructions further include instructions to determine the sequence to improve an aggregated vehicle parameter for the fleet of vehicles, the aggregated vehicle parameter being combined values of the vehicle parameter for all of the vehicles in the fleet of vehicles.

24. The system of claim 16, wherein the vehicle parameter is a maximum vehicle speed, the instructions further include instructions to actuate the one or more components of the host vehicle to maintain a current speed of the host vehicle that does not exceed the maximum vehicle speed.

25. The system of claim 16, wherein the vehicle parameter is a minimum vehicle spacing, and the instructions further include instructions to determine the sequence to maintain a distance between the host vehicle and the target vehicle that exceeds the minimum vehicle spacing.

26. A method, comprising:
predicting a path of a target vehicle through an intersection;
determining a sequence for the target vehicle and a host vehicle to cross through the intersection based the predicted path of the target vehicle and a planned path of the host vehicle, the sequence determined to improve a vehicle parameter among a fleet of vehicles including the host vehicle and the target vehicle;
transmitting the determined sequence to the target vehicle; and
actuating one or more components to move the host vehicle according to the determined sequence.

27. The method of claim 26, further comprising adjusting the planned path of the host vehicle based on the sequence.

28. The method of claim 26, wherein the vehicle parameter includes at least one of a vehicle acceleration, a vehicle acceleration duration, a vehicle speed, emission production rate, or a fuel consumption rate.

29. The method of claim 26, further comprising receiving a planned path from the target vehicle and adjusting the planned path of the host vehicle based on the planned path of the target vehicle.

30. The method of claim 26, wherein the vehicle parameter is a carbon dioxide production rate and the method further comprises determining the sequence to reduce the carbon dioxide production rate of the fleet of vehicles below a production rate threshold.

31. The method of claim 26, further comprising actuating the components to adjust at least one of lateral movement or longitudinal movement of the host vehicle.

32. The method of claim 26, wherein the vehicle parameter is a traffic rate, the traffic rate being a maximum number of vehicles traveling through the intersection during a specified period of time.

33. The method of claim 26, further comprising determine the sequencing to improve an aggregated vehicle parameter for the fleet of vehicles, the aggregated vehicle parameter being combined values of the vehicle parameter for all of the vehicles in the fleet of vehicles.

34. The method of claim 26, wherein the vehicle parameter is a maximum vehicle speed, the method further comprises actuating the one or more components of the host vehicle to maintain a current speed of the host vehicle that does not exceed the maximum vehicle speed.

25. The method of claim 26, wherein the vehicle parameter is a minimum vehicle spacing, and the method further comprises determining the sequence to maintain a distance between the host vehicle and the target vehicle that exceeds the minimum vehicle spacing.
